(19) United States
(12) Patent Application Publication
(10) Pub. No.: US 2006/0248215 A1
(43) Pub. Date: Nov. 2, 2006

(54) Information processing apparatus and information processing method

(75) Inventor: Naozumi Koshino, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kabushiki Kaisha Toshiba

(21) Appl. No.: 11/403,836

(22) Filed: Apr. 14, 2006

(30) Foreign Application Priority Data
Apr. 28, 2005 (JP) 2005-132055

(51) Int. Cl. G06F 15/16

(52) U.S. Cl. 709/231

(57) ABSTRACT

According to one embodiment, in an information processing method, a content providing source is accessed to periodically try to acquire content, the acquisition success ratio of the content is managed based on a content acquisition try result, and saving of the acquired content is controlled based on the acquisition success ratio.

### CROSS-REFERENCE TO RELATED APPLICATIONS

This application is based upon and claims the benefit of priority from Japanese Patent Application No. 2005-132055, filed Apr. 28, 2005, the entire contents of which are incorporated herein by reference.

### BACKGROUND

1. Field

One embodiment of the invention relates to an information processing apparatus and information processing method for accessing a content providing server connected to a wired or wireless network, acquiring content from the content providing server, and displaying the acquired content and outputting audio data.

2. Description of the Related Art

In recent years, various proposals have been made for a digital device which accesses a content providing server via a network such as the Internet, acquires content from the content providing server, and displays the acquired content and outputs audio data.

In such a digital device for acquiring content via a network, the content may not be acquired due to a failure on the network side including a content providing server. Based on the assumption of such situation, Jpn. Pat. Appln. KOKAI Publication No. 2000-99435 discloses the following technique. In a system in which a client and a plurality of information broadcast servers for providing the same service are connected to a network, the information broadcast servers are switched when a failure occurs on the network side including the information broadcast servers during connection between the client and the information broadcast servers.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram showing the schematic arrangement of an information processing apparatus (client) according to an embodiment of the invention;

FIG. 2 is a view showing the connection between the client and each content providing server, and showing content provided (held) by each of the content providing servers according to the embodiment;

FIG. 3 is a view showing the connection between the client and each of the content providing servers, and showing a case in which the client holds all content to be played back based on a playlist according to the embodiment;

FIG. 4 is a view showing the connection between the client and each of the content providing servers, and showing a case in which the client holds, of all the content to be played back based on the playlist, only content which is relatively difficult to acquire according to the embodiment;

FIG. 5 is a flowchart for explaining playlist playback according to the embodiment; and

FIG. 6 is a flowchart for explaining an example of periodic download according to the embodiment.

### DETAILED DESCRIPTION

Various embodiments according to the invention will be described hereinafter with reference to the accompanying drawings. In general, according to one embodiment of the invention, an information processing method comprises accessing a content providing source to periodically try to acquire content, managing an acquisition success ratio of the content based on a content acquisition trial result, and controlling saving of the acquired content based on the acquisition success ratio.

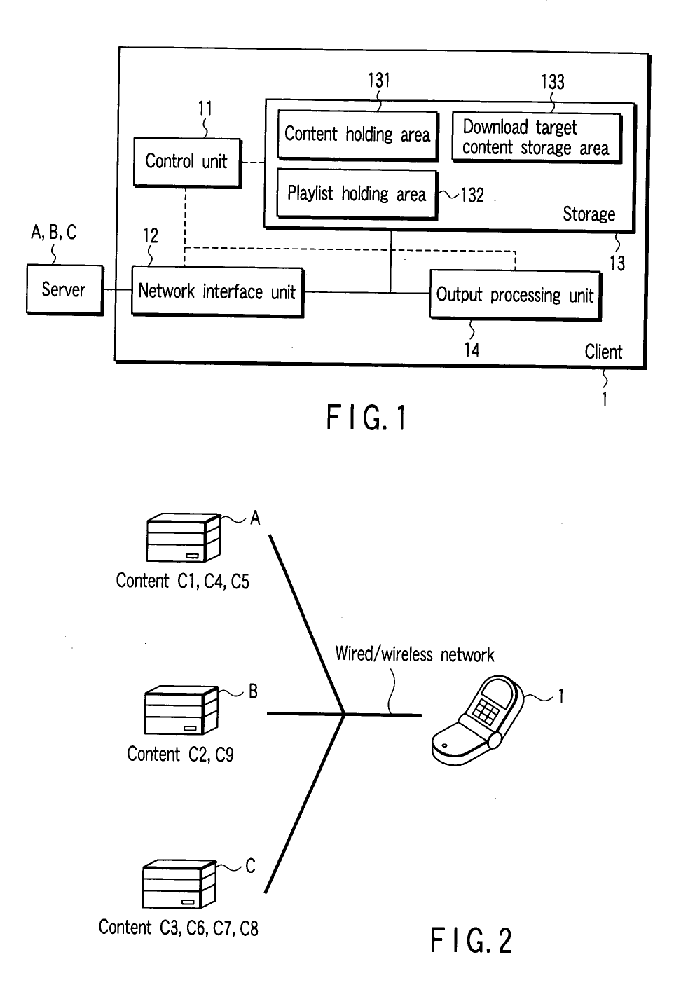

FIG. 1 is a block diagram showing the schematic arrangement of an information processing apparatus (client) according to an embodiment of the invention. As shown in FIG. 1, a client 1 includes a control unit 11, network interface unit 12, storage 13, output processing unit 14, and the like.

The control unit 11 controls the network interface unit 12 to control acquisition of content provided by content providing servers A, B, and C via a wired or wireless network. The control unit 11 also manages a content acquisition success ratio based on the content acquisition result. Based on this acquisition success ratio, the control unit 11 controls saving of the acquired content. That is, the control unit 11 saves the acquired content when its acquisition success ratio is lower than a specified value, and does not save the acquired content (deletes the acquired content) when its acquisition success ratio is equal to or higher than the specified value (or when the acquired content is already present). Thus, the control unit 11 functions as an acquisition control unit designed to control acquisition of content, a management unit designed to manage the acquisition success ratio of the content, and a saving control unit designed to control saving of the content. These functions will be described later in detail.

The network interface unit 12 accesses the content providing servers A, B, and C via the wired or wireless network to acquire the content. That is, the network interface unit 12 functions as an acquisition unit designed to acquire the content.

The storage 13 includes a content holding area 131, playlist holding area 132, and download target content information storage area 133. In the content holding area 131, contents which are so determined as to be saved by the control unit 11 are saved. In the playlist holding area 132, a playlist serving as playback control information is saved. For example, in addition to control information for playing back the first content and then playing back the second content after playback of the first content, the playlist includes storage destination information indicating the first content storage destination (e.g., the address of a content providing server A), and the second content storage destination (e.g., the address of a content providing server B). In the download target content information storage area 133, a list of content which has failed to be acquired is stored.

The output processing unit 14 includes a moving image/still image decoder and an audio decoder to decode video or audio content acquired from the network interface unit 12 or stored in the content holding area 131 of the storage 13, and output the decoded content.

FIG. 2 is a view showing the connection between the client 1 and each of the content providing servers A, B, and C, and showing examples of content provided (held) by each of the content providing servers A, B, and C. As shown in FIG. 2, for example, the client 1 can be connected to the content providing servers A, B, and C. The content providing server A can provide content C1, C4, and C5. The content providing server B can provide content C2 and C9. The content providing server C can provide content C3, C6, C7, and C8.

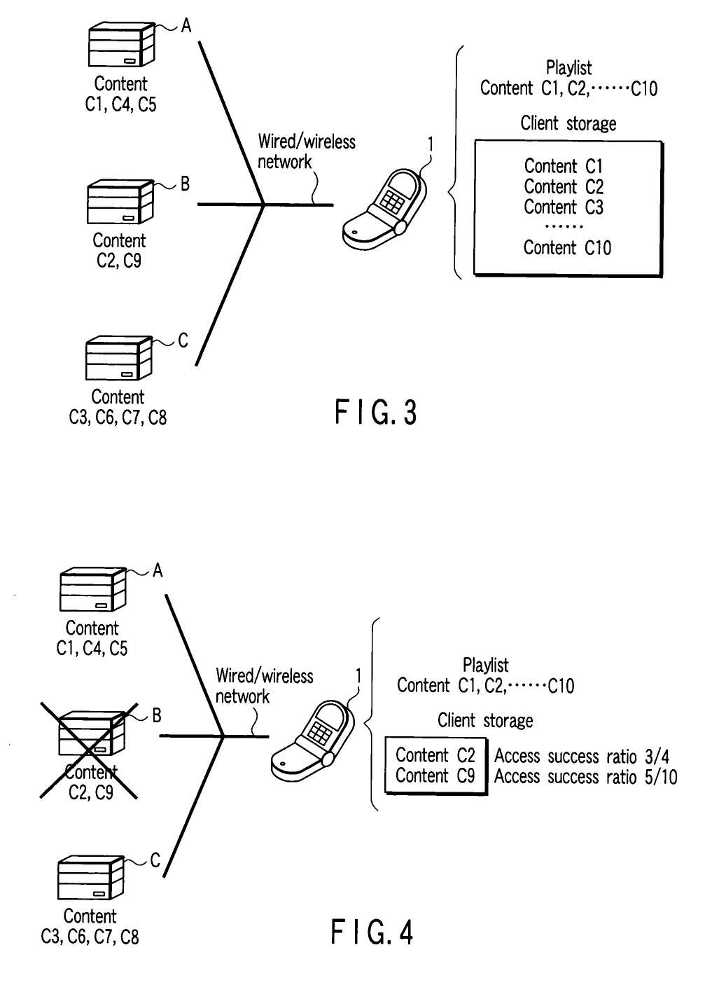

FIG. 3 is a view showing the connection between the client 1 and each of the content providing servers A, B, and C, and showing a case in which the client 1 holds all content to be played back based on the playlist. As shown in FIG. 3, for example, the storage 13 (playlist holding area 132) of the client 1 holds control information for controlling (sequential) playback of content C1, C2, C3, C4, C5, C6, C7, C8, C9, and C10, and the playlist including the pieces of storage destination information of content C1, C2, C3, C4, C5, C6, C7, C8, C9, and C10.

In this case, in order to play back the content based on the playlist, the client 1 accesses content providing server A to acquire content C1, C4, and C5, accesses content providing server B to acquire content C2 and C9, and accesses content providing server C to acquire content C3, C6, C7, and C8. Upon holding all content C1, C2, C3, C4, C5, C6, C7, C8, C9, and C10, the client 1 (sequentially) plays back them. As a result, in this case, large-capacity storage is required to save all the content required by the playlist.

In contrast to this, FIG. 4 is a view showing the connection between the client 1 and each of content providing servers A, B, and C, and showing a case in which the client 1 holds, of all the content to be played back based on the playlist, only content which is relatively difficult to acquire. As shown in FIG. 4, assume that content C2 and C9 are difficult to acquire from content providing server B. In this case, the client 1 periodically tries to acquire content C2 and C9 from content providing server B. When acquisition has succeeded, only content C2 and C9 which are relatively difficult to acquire are saved. After acquisition has succeeded, the client 1 also periodically tries to acquire content C2 and C9 from content providing server B, and updates the acquisition success ratio (access success ratio).

In order to play back the content based on the playlist, the client 1 accesses content providing server A to play back acquired content C1, C4, and C5 (content C1, C4, C5 are not saved), accesses content providing server C to play back acquired content C3, C6, C7, and C8 (content C3, C6, C7, and C8 are not saved), and plays back saved content C2 and C9. With this operation, any defect in playlist playback can be avoided without any large-capacity storage.

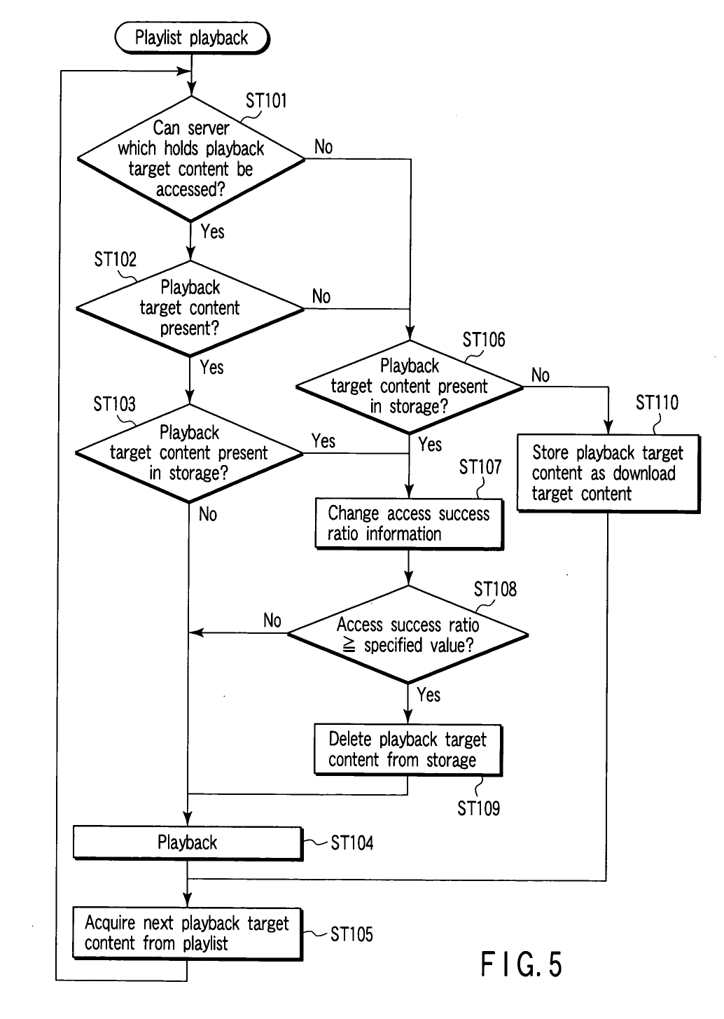

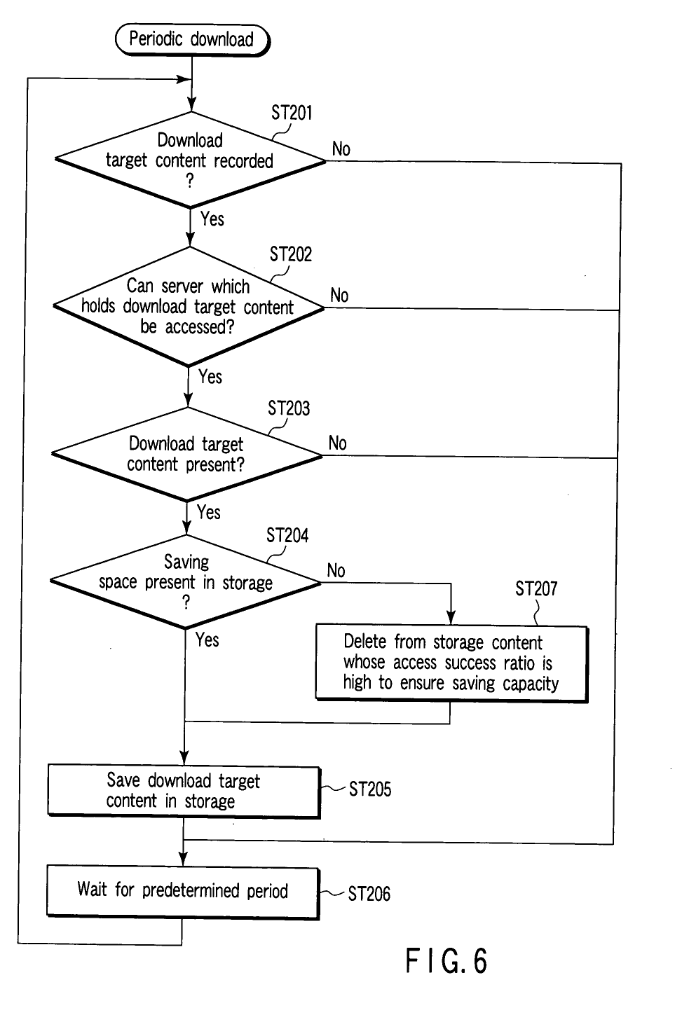

An example of playlist playback will be described below with reference to FIG. 5, and an example of periodic download will be described below with reference to FIG. 6.

First, the client 1 (control unit 11) acquires the first playback target content from the playlist held in the storage 13 (playlist holding area 132), and accesses the content providing server which holds this playback target content. When the client 1 has succeeded in accessing the content providing server which holds the playback target content (YES in step ST101), the accessed content providing server saves the playback target content (YES in step ST102), and this playback target content has been neither downloaded nor saved in the storage 13 (content holding area 131) (NO in step ST103), this playback target content is played back (step ST104). Next, the client 1 acquires the next playback target content from the playlist, and tries to access the content providing server which holds the next playback target content (step ST101).

As the client 1 has succeeded in acquiring the playback target content, the acquisition success ratio information (access success ratio information) of this playback target content may be managed. For example, the identification information (title name or the like) and acquisition success ratio of the playback target content are stored in the content holding area 131. In this case, when the acquisition success ratio of the playback target content is equal to or higher than a specified value, this playback target content is not saved. Hence, larger free space can be ensured in the storage 13. Additionally, since the acquisition success ratio of the playback target content is equal to or higher than the specified value, the playback target content can be acquired at relatively high probability when required. Thus, no defect occurs in playback.

When the client 1 has failed to access the content providing server which holds the playback target content (NO in step ST101), or when the accessed content providing server does not save the playback target content (NO in step ST102), it is checked whether the playback target content has been downloaded and saved in the storage 13 (content holding area 131) (step ST106). When the playback target content has been downloaded and saved in the storage 13 (content holding area 131) (YES in step ST106), the acquisition success ratio of the playback target content is updated (changed) (step ST107). In this case, the acquisition success ratio decreases (step ST107). Therefore, the acquisition success ratio is lower than the specified value (NO in step ST108), and the playback target content saved in the storage 13 (content holding area 131) is played back (step ST104).

When the client 1 has succeeded in accessing the content providing server which holds the playback target content (YES in step ST101), the accessed content proving server saves the playback target content (YES in step ST102), and the playback target content has been downloaded and saved in the storage 13 (content holding area 131) (YES in step ST103), the acquisition success ratio of this playback target content is updated (changed) (step ST107). In this case, the acquisition success ratio increases (step ST107). With this operation, when the acquisition success ratio becomes equal to or higher than the specified value (YES in step ST108), the playback target content saved in the storage 13 (content holding area 131) is deleted (step ST109), and the playback target content acquired from the content providing server is played back (step ST104). In this case, since the acquisition success ratio of the playback target content is high (equal to or higher than the specified value), this playback target content is not saved. As described above, larger free space can be ensured in the storage 13 by deleting, from the storage 13 (content holding area 131), the content whose acquisition success ratio is high. Additionally, since the acquisition success ratio of the playback target content is equal to or higher than the specified value, this playback target content can be acquired at relatively high probability when required. Therefore, no defect occurs in playback. Note that the playback target content may be deleted (step ST109) after playback (step ST104).

When the client 1 has failed to access the content providing server which holds the playback target content (NO in step ST101), or when the accessed content providing server does not save the playback target content (NO in step ST102), if this playback target content has been neither downloaded nor saved in the storage 13 (content holding area 131) (NO in step ST106), the playback target content is registered as the download target content in the download target content information storage area 133 (step ST110).

The client 1 (control unit 11) checks whether the download target content is registered in the download target content information storage area 133. When the download target content is registered (YES in step ST201), the client 1 tries to access the content providing server which holds the download target content. When the client 1 has succeeded in accessing the content providing server which holds the download target content (YES in step ST202), the accessed content providing server saves the download target content (YES in step ST203), and the storage 13 has free space for saving the download target content (YES in step ST204), the download target content is saved in the storage 13 (content holding area 131) (step ST205). As a result, the acquisition success ratio of the download target content is updated. In this case, the acquisition success ratio increases.

When the storage 13 has no free area for storing the download target content (NO in step ST204), i.e., when the storage 13 has free space which is smaller than required, in order to ensure a required capacity, the client 1 (control unit 11) deletes, of the plurality of saved content, the content whose acquisition success ratio is high. The client 1 (control unit 11) also preferentially deletes, of the plurality of content whose acquisition success ratio is the same in the storage 13, the content whose access trial count is large.

After a predetermined time elapses (step ST206), the client 1 (control unit 11) retries accessing the download target content registered in the download target content information storage area 133. That is, the client 1 (control unit 11) periodically tries to acquire the content which has failed to be acquired, and also periodically tries to acquire the content even after the client 1 has succeeded in acquiring the content. Based on the periodic attempts to acquire the content, the acquisition success ratio of the content is updated. As a result, the client 1 (control unit 11) determines necessity/nonnecessity of saving the content based on the updated acquisition success ratio, and controls saving of the content based on determination of whether the content must be saved. That is, the client 1 (control unit 11) saves (keeps a save state unchanged) the content when the updated acquisition success ratio is lower than the specified value, and deletes the saved content when the updated acquisition success ratio becomes equal to or higher than the specified value.

Note that the client 1 (control unit 11) repeatedly tries to acquire the content (download target content) which has failed to be acquired, a predetermined number of times at the first time interval. When the client 1 has failed to acquire the content (download target content) even after the predetermined number of attempts at the first time interval, the client 1 may try to acquire the content (download target content) which has failed to be acquired, a predetermined number of times at the second time interval longer than the first time interval.

As described above, the client 1 tries to acquire the content from the content providing server in order to play back the content based on the playlist. In this case, when the content cannot be acquired, the client 1 periodically tries to acquire the content which has failed to be acquired. When the content can be acquired, the client 1 temporarily saves the acquired content, and manages the acquisition success ratio of this content. The client 1 periodically tries to acquire the content, and updates the acquisition success ratio of this content. When the acquisition success ratio is lower than a specified value, the content is continuously saved. When the acquisition success ratio becomes equal to or higher than the specified value, the saved content is deleted. With this process, the storage capacity can be effectively used (without large-capacity storage), and any defect in playback can be avoided at high probability (the content can be played back based on the playlist).

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
an acquisition unit configured to access a content providing source to acquire content;
an acquisition control unit configured to control the acquisition unit to acquire the content, and retry acquiring the content at a predetermined timing when the content has failed to be acquired;
a management unit configured to manage an acquisition success ratio of the content based on an acquisition result of the content acquired by the acquisition control unit; and
a saving control unit configured to control, based on the acquisition success ratio, saving of the content acquired by the acquisition unit.

2. An apparatus according to claim 1, wherein
the acquisition control unit controls acquisition of first content from a first content providing source, and controls acquisition of second content from a second content providing source,
the management unit manages an acquisition success ratio for each of the first content and the second content, and
the saving control unit determines, based on the acquisition success ratio for each of the first content and the second content, necessity/nonnecessity of saving the first content and the second content, and controls, based on the determination result, saving of the first content and the second content which are acquired by the acquisition unit.

3. An apparatus according to claim 1, wherein
the acquisition control unit controls, based on playback control information for playing back first content and second content, acquisition of the first content from a first content providing source, and acquisition of the second content from a second content providing source,
the management unit manages an acquisition success ratio for each of the first content and the second content, and
the saving control unit determines, based on the acquisition success ratio for each of the first content and the second content, necessity/nonnecessity of saving the first content and the second content, and controls, based on the determination result, saving of the first content and the second content which are acquired by the acquisition unit.

4. An apparatus according to claim 1, wherein the saving control unit saves the content based on an acquisition success ratio lower than a specified value, and does not save the content based on an acquisition success ratio not lower than the specified value.

5. An apparatus according to claim 1, wherein the acquisition control unit tries, a predetermined number of times at a first time interval, to acquire the content which has failed to be acquired, and tries, a predetermined number of times at a second time interval longer than the first time interval, to acquire the content which has failed to be acquired even when acquisition of the content has failed after the predetermined number of times of trying at the first time interval.

6. An apparatus according to claim 1, wherein
the acquisition control unit periodically tries to acquire the content which has failed to be acquired, and further periodically tries to acquire the content even after acquisition of the content has succeeded,
the management unit updates the acquisition success ratio of the content based on the periodical tries to acquire the content using the acquisition control unit, and
the saving control unit determines necessity/normecessity of saving the content based on the updated acquisition success ratio, and controls saving of the content based on the determination result.

7. An apparatus according to claim 6, wherein the saving control unit deletes the content in a saving destination by updating the acquisition success ratio of the content which is lower than a specified value to the acquisition success ratio of the content which is not lower than the specified value.

8. An apparatus according to claim 3, wherein
the acquisition control unit tries to acquire the first content and the second content based on the playback control information,
the management unit updates the acquisition success ratio for each of the first content and the second content based on the tries to acquire the first content and the second content using the acquisition control unit, and
the saving control unit determines necessity/nonnecessity of saving the first content and the second content based on the updated acquisition success ratio, and controls saving of the first content and the second content based on the determination result.

9. An apparatus according to claim 1, wherein the saving control unit deletes, of a plurality of content saved in a saving destination, content whose acquired success ratio is high, when the saving destination has free space smaller than required.

10. An apparatus according to claim 9, wherein the saving control unit preferentially deletes, of a plurality of content whose acquisition success ratios are the same in the saving destination, content whose access try count is large.

11. An information processing method comprising:
accessing a content providing source to periodically try to acquire content;
managing an acquisition success ratio of the content based on a content acquisition try result; and
controlling saving of the acquired content based on the acquisition success ratio.

12. A method according to claim 11, further comprising
periodically trying to acquire the content which has failed to be acquired, and further periodically trying to acquire the content even after acquisition of the content has succeeded,
updating the acquisition success ratio of the content based on the periodical tries to acquire the content, and
controlling saving of the acquired content based on the updated acquisition success ratio.
